(19) United States
(12) Patent Application Publication
(10) Pub. No.: US 2026/0339666 A1
(43) Pub. Date: Oct. 29, 2026

(54) SYSTEM AND METHOD FOR VALIDATING DATA TRANSFERS IN A DECENTRALIZED PROTOCOL VIA EMBEDDED RULE LOGIC

(71) Applicant: BANK OF AMERICA CORPORATION, Charlotte, NC (US)

(72) Inventors: Nithya C., Chennai (IN); Yugandhar Jaini, Hyderabad (IN); Meenakshi Meenakshisundaram, Chennai (IN)

(73) Assignee: BANK OF AMERICA CORPORATION, Charlotte, NC (US)

(21) Appl. No.: 19/192,929

(22) Filed: Apr. 29, 2025

(51) Int. Cl. G06F 9/30

(52) U.S. Cl. CPC G06F 9/30032; G06F 9/30029

(57) ABSTRACT

Systems, computer program products, and methods are described herein for validating data transfers in a decentralized protocol via embedded rule logic. The present disclosure includes receiving rule documentation data related to governing of data conditions of data transfers between nodes, converting the received rule documentation into a structured digital rule, generating, using a first small language model, at least one configuration file based on the structured digital rule as a first input, generating, using a second small language model, smart contract language code based on the structured digital rule as a second input, and integrating embedded logic instructions comprising the at least one configuration file and the smart contract language code to form a smart contract on a distributed ledger.

### TECHNOLOGICAL FIELD

Example implementations of the present disclosure relate to a system and method for validating data transfers in a decentralized protocol via embedded rule logic.

### BACKGROUND

Currently, cross-border data transfer systems rely on a fragmented, often multi-entity architectures in which data traverses several independent nodes before a data transfer is completed. These data transfers occur across heterogeneous platforms that do not have uniform data models, thereby causing delays and ambiguity in understanding data transfer status at any given time. Due to inadequate traceability and transparency of data transfers, reconciliation processes require manual intervention, operational overhead, and domain-specific expertise. Moreover, regulatory requirements, which vary across jurisdictions, are often defined in documentation that is not readily able to be integrated, thereby preventing real-time validation, dynamic adaptation to emerging infrastructures, or the like. The lack of a unified global data registry, absence of normalized data standards, and unavailability of systems capable of contextual visualization of data flow, prevent scalable and auditable governance of cross-border data transfers. As such, there is a need for a system and method for validating data transfers in a decentralized protocol via embedded rule logic.

### BRIEF SUMMARY

Systems, methods, and computer program products are provided for validating data transfers in a decentralized protocol via embedded rule logic.

In one aspect, a system for validating data transfers in a decentralized protocol via embedded rule logic is presented. The system may include a processing device, and a non-transitory storage device containing instructions, when executed by the processing device, the instructions cause the processing device to perform the steps of receiving rule documentation data related to governing of data conditions of data transfers between nodes, converting the received rule documentation into a structured digital rule, generating, using a first small language model, at least one configuration file based on the structured digital rule as a first input, generating, using a second small language model, smart contract language code based on the structured digital rule as a second input, and integrating embedded logic instructions including the at least one configuration file and the smart contract language code to form a smart contract on a distributed ledger.

In some implementations, the instructions may further cause the processing device to perform the steps of receiving an initiation signal for a data transfer, wherein the initiation signal may include a node path defined by at least a transmitting node and a receiving node, retrieving applicable embedded logic instructions from the smart contract applicable to each node in the node path, analyzing, autonomously at each node of the node path, the data transfer against the embedded logic instructions, and arbitrating the data transfer based on the analysis of the data transfer against the embedded logic instructions, wherein the data transfer is accepted upon a first condition where the data transfer meets the embedded logic instructions, and wherein the data transfer is rejected upon a second condition where the data transfer does not meet the embedded logic instructions.

In some implementations, upon occurrence of the second condition, the instructions may further cause the processing device to perform the steps of generating an alert indicating the occurrence of the second condition, transmitting, to an endpoint device, the alert, and causing the alert to be displayed on the endpoint device.

In some implementations, the first small language model is trained using sample configuration files.

In some implementations, the second small language model is trained using sample smart contract code.

In some implementations, the alert may include explained reasons for the second condition.

In some implementations, rejecting the data transfer upon the second condition may include halting the data transfer, flagging the data transfer in the distributed ledger, and documenting in the distributed ledger reasons for the second condition.

In another aspect, a computer program product for validating data transfers in a decentralized protocol via embedded rule logic is presented. The computer program product may have a non-transitory computer-readable medium having code causing an apparatus to receive rule documentation data related to governing of data conditions of data transfers between nodes, convert the received rule documentation into a structured digital rule, generate, using a first small language model, at least one configuration file based on the structured digital rule as a first input, generate, using a second small language model, smart contract language code based on the structured digital rule as a second input, and integrate embedded logic instructions including the at least one configuration file and the smart contract language code to form a smart contract on a distributed ledger.

In some implementations, the code may further cause the apparatus to receive an initiation signal for a data transfer, wherein the initiation signal may include a node path defined by at least a transmitting node and a receiving node, retrieve applicable embedded logic instructions from the smart contract applicable to each node in the node path, analyze, autonomously at each node of the node path, the data transfer against the embedded logic instructions, and arbitrate the data transfer based on the analysis of the data transfer against the embedded logic instructions, wherein the data transfer is accepted upon a first condition where the data transfer meets the embedded logic instructions, and wherein the data transfer is rejected upon a second condition where the data transfer does not meet the embedded logic instructions.

In some implementations, upon occurrence of the second condition, the code may further cause the apparatus to generate an alert indicating the occurrence of the second condition, transmit, to an endpoint device, the alert, and cause the alert to be displayed on the endpoint device.

In some implementations, the first small language model is trained using sample configuration files.

In some implementations, the second small language model is trained using sample smart contract code.

In some implementations, the alert may include explained reasons for the second condition.

In some implementations, rejecting the data transfer upon the second condition may include halting the data transfer, flagging the data transfer in the distributed ledger, and documenting in the distributed ledger reasons for the second condition.

In yet another aspect, a method for validating data transfers in a decentralized protocol via embedded rule logic is presented. The method may include receiving rule documentation data related to governing of data conditions of data transfers between nodes, converting the received rule documentation into a structured digital rule, generating, using a first small language model, at least one configuration file based on the structured digital rule as a first input, generating, using a second small language model, smart contract language code based on the structured digital rule as a second input, and integrating embedded logic instructions including the at least one configuration file and the smart contract language code to form a smart contract on a distributed ledger.

In some implementations, the method may further include receiving an initiation signal for a data transfer, wherein the initiation signal may include a node path defined by at least a transmitting node and a receiving node, retrieving applicable embedded logic instructions from the smart contract applicable to each node in the node path, analyzing, autonomously at each node of the node path, the data transfer against the embedded logic instructions, and arbitrating the data transfer based on the analysis of the data transfer against the embedded logic instructions, wherein the data transfer is accepted upon a first condition where the data transfer meets the embedded logic instructions, and wherein the data transfer is rejected upon a second condition where the data transfer does not meet the embedded logic instructions.

In some implementations, upon occurrence of the second condition, the method may further include generating an alert indicating the occurrence of the second condition, transmitting, to an endpoint device, the alert, and causing the alert to be displayed on the endpoint device.

In some implementations, the first small language model is trained using sample configuration files.

In some implementations, the second small language model is trained using sample smart contract code.

In some implementations, rejecting the data transfer upon the second condition may include halting the data transfer, flagging the data transfer in the distributed ledger, and documenting in the distributed ledger reasons for the second condition.

The above summary is provided merely for purposes of summarizing some example implementations to provide a basic understanding of some aspects of the present disclosure. Accordingly, it will be appreciated that the above-described implementations are merely examples and should not be construed to narrow the scope or spirit of the disclosure in any way. It will be appreciated that the scope of the present disclosure encompasses many potential implementations in addition to those here summarized, some of which will be further described below.

### BRIEF DESCRIPTION OF THE DRAWINGS

Having thus described implementations of the disclosure in general terms, reference will now be made the accompanying drawings. The components illustrated in the Figures may or may not be present in certain implementations described herein. Some implementations may include fewer (or more) components than those shown in the Figures.

FIGS. 1A-1C illustrate technical components of an exemplary distributed computing environment for validating data transfers in a decentralized protocol via embedded rule logic, in accordance with implementations of the disclosure;

FIGS. 2A-2B illustrate an exemplary distributed ledger technology (DLT) architecture, in accordance with implementations of the disclosure;

FIG. 3 illustrates an exemplary generative artificial intelligence model subsystem, in accordance with implementations of the disclosure;

FIGS. 4A-4B illustrate a process flow for validating data transfers in a decentralized protocol via embedded rule logic, in accordance with implementations of the disclosure; and

FIG. 5 illustrates an architecture layout of an exemplary system for validating data transfers in a decentralized protocol via embedded rule logic, in accordance with implementations of the disclosure.

### DETAILED DESCRIPTION

Implementations of the present disclosure will now be described more fully hereinafter with reference to the accompanying drawings, in which some, but not all, implementations of the disclosure are shown. Indeed, the disclosure may be implemented in many different forms and should not be construed as limited to the implementations set forth herein; rather, these implementations are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” may be also used herein. Furthermore, when it may be said herein that something may be “based on” something else, it may be based on one or more other things as well. In other words, unless expressly indicated otherwise, as used herein “based on” means “based at least in part on” or “based at least partially on.” Like numbers refer to like elements throughout.

As used herein, a “data transfer” may refer to the transmission or relay of structured or unstructured data between two or more nodes, entities, or systems within a distributed network (otherwise referred to as a distributed computing environment). Such data transfers may represent the movement of payloads containing transactional data (e.g., financial resources) state change instructions, records requiring validation, transformation, or logging, or the like. In some implementations, data transfers may correspond to transactions (e.g., resource transfers, resource exchanges, settlement requests, payment instructions, or the like), but may also include other domain-specific exchanges such as identity assertions, audit events, compliance attestations, or inter-system coordination signals. Data transfers may occur in real-time or batch mode, and may be encapsulated in messages, packets, smart contract invocations, or other protocol-dependent formats.

As used herein, an “entity” may be any institution employing information technology resources and particularly technology infrastructure configured for processing large amounts of data. Typically, these data can be related to the people who work for the entity, its products or applications, the customers or any other aspect of the operations of the entity. As such, the entity may be any institution, group, association, financial institution, establishment, company, union, authority or the like, employing information technology resources for processing large amounts of data.

As used herein, a “user” may be an individual associated with an entity. As such, in some implementations, the user may be an individual having past relationships, current relationships or potential future relationships with an entity. In some implementations, the user may be an employee (e.g., an associate, a project manager, an IT specialist, a manager, an administrator, an internal operations analyst, or the like) of the entity or enterprises affiliated with the entity.

As used herein, a “user interface” or “display” may be a point of human-computer interaction and communication in a device that allows a user to input information, such as commands or data, into a device, or that allows the device to output information to the user. For example, the user interface includes a graphical user interface (“GUI”) or an interface to input computer-executable instructions that direct a processing device to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. In some implementations, “engine” may be used interchangeably with “module” or “model”. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some implementations, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system. In some implementations, an engine may implement a machine learning model or generative artificial intelligence (“AI”) model to perform functions as a foundation for the larger piece of software that drives the functionality of the software. The machine learning model or generative AI model for any given engine may be self-contained (e.g., without interaction with other engines), or the machine learning model or generative AI model may be shared across one or more engines. In other words, some implementations of the larger piece of software many implement multiple machine learning models or generative AI models to perform functions of the various engines. In other implementations, a single machine learning model or generative AI model may be shared across one or more engines to perform the functions attributed thereto as described herein.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

It should be understood that the word “exemplary” may be used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that an element matches a predetermined criterion, including that a threshold has been met, passed, exceeded, and so on.

In data transfer environments that span heterogeneous domains and governance boundaries, an ongoing technical problem exists from the absence of an integrated framework capable of dynamically orchestrating, validating, and tracing data packets (e.g., data related to transactions) across multiple intermediary systems. Each intermediary typically operates under localized protocols and logic without visibility into upstream or downstream data flow contexts. As a result, end-to-end data lifecycle state becomes opaque and leads to indeterminacy regarding whether a particular data packet has been received, transformed, delayed, or rejected. This opacity is further increased when data traverses jurisdictional boundaries subject to differing compliance constraints (e.g., semantic structures, synchronization tolerances, or the like). The absence of a unified orchestration layer capable of interpreting context, schema, and regulatory metadata in real-time results in significant friction, poor observability, and systemic brittleness.

Current solutions attempt to address this technical challenge through static integration layers, point-to-point application programming interfaces (APIs), and manual coordination protocols between siloed systems. These solutions typically involve platforms that lack semantic awareness of the data they route and possess no adaptive capacity to ingest changing validation logic, compliance requirements, platform-specific formatting changes, or the like. Furthermore, regulatory directives and compliance frameworks remain codified in unstructured documentation formats, preventing automated enforcement or version-aware validation. Attempts to digitize compliance checks often result in partial, jurisdiction-specific implementations that fail to interoperate globally. The absence of a global registry has led to systemic rigidity and prohibitive costs in maintaining cross-domain data interoperability. This has created a long-felt but unresolved need for a scalable, adaptable system that enables real-time state awareness, validation traceability, and context-aware coordination of heterogeneous data flows across boundaries of regulation.

Addressing these challenges requires the establishment of a system and method for validating data transfers in a decentralized protocol via embedded rule logic, which introduces a dynamic, machine-readable representation of compliance logic that can be executed autonomously at each node in a distributed environment. This approach may eliminate reliance on static rule interpretation or manual regulatory enforcement, thereby enabling real-time validation of data transfers across heterogeneous systems.

To do so, the system may ingest unstructured regulatory documents from various sources and convert these unstructured regulatory documents into structured digital data (e.g., digital rules). By then using automated interpretation by small language models, the system may produce a structured configuration file (e.g., in YAML format) representing declarative rule sets, and a corresponding set of executable smart contract logic operable within a decentralized ledger framework. These outputs may be deployable to validate incoming data transfers at runtime, with system logic adapting dynamically based on rule updates, node-specific conditions, and/or detected transfer paths. For example, the system may receive a signal that a data transfer is to occur. Such signal may include data or metadata pertaining to the route through which the data is to be transferred, including the source node (i.e., a transmitting node), destination node (i.e., a receiving node). Applicable embedded logic instructions from the smart contract applicable to the nodes in the node path are then retrieved and used by the system to analyze the data transfer against. If the data transfer meets the embedded logic required, the data transfer is accepted and proceeds accordingly. However, if the data transfer does not meet the embedded logic, the data transfer is rejected, which may lead to notifications, alerts, or the like, and subsequent notation thereof in the distributed ledger.

What is more, the present disclosure provides a technical solution to a technical problem. As described herein, the technical problem includes the inability of existing systems to apply non-uniform compliance constraints to distributed data flows in a uniform, executable, and scalable manner. The present disclosure embraces an improvement over existing solutions by allowing for automated rule interpretation, encoding, and enforcement across distributed nodes (i) with fewer steps to achieve the solution (e.g., by eliminating manual translation of rule documents into executable logic), thus reducing the amount of network resources, such as processing resources, storage resources, network resources, and/or the like, that are being used, (ii) providing a more accurate solution to problem, thus reducing the number of resources required to remedy any errors made due to a less accurate solution (e.g., preventing acceptance of invalid data transfers due to outdated or misapplied compliance logic), (iii) removing manual input and waste from the implementation of the solution, thus improving speed and efficiency of the process and conserving network resources (e.g., by automating the mapping of natural language regulations to machine-enforceable rules), (iv) determining an optimal amount of resources that need to be used to implement the solution, thus reducing network traffic and load on existing network resources (e.g., by locally executing validation logic at edge nodes without requiring centralized orchestration). In other words, the solution may bypass a series of steps previously implemented, thus further conserving network resources. Furthermore, the technical solution described herein uses a rigorous, computerized process to perform specific tasks and/or activities that were not previously performed.

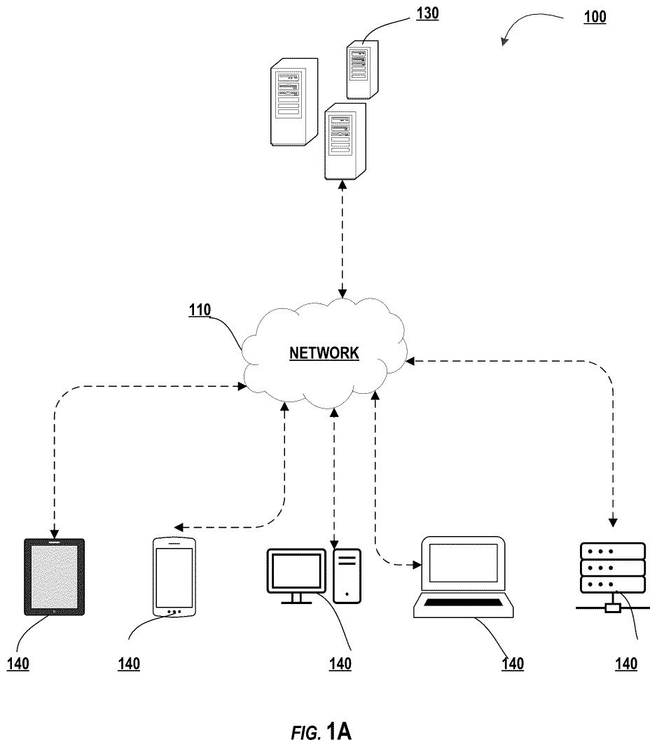

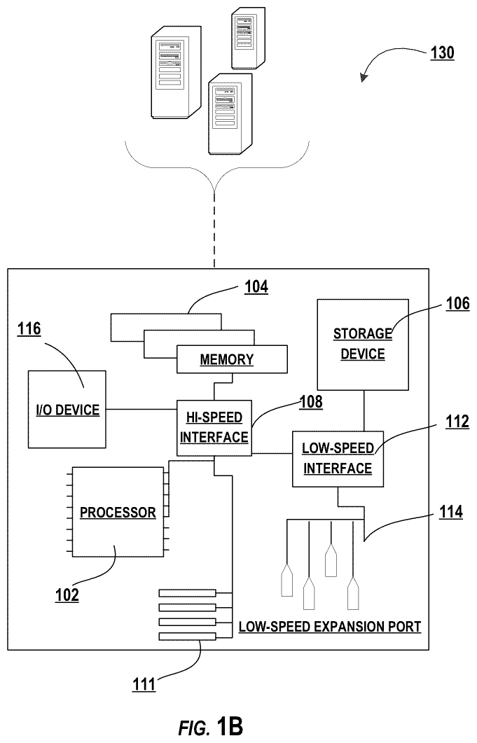

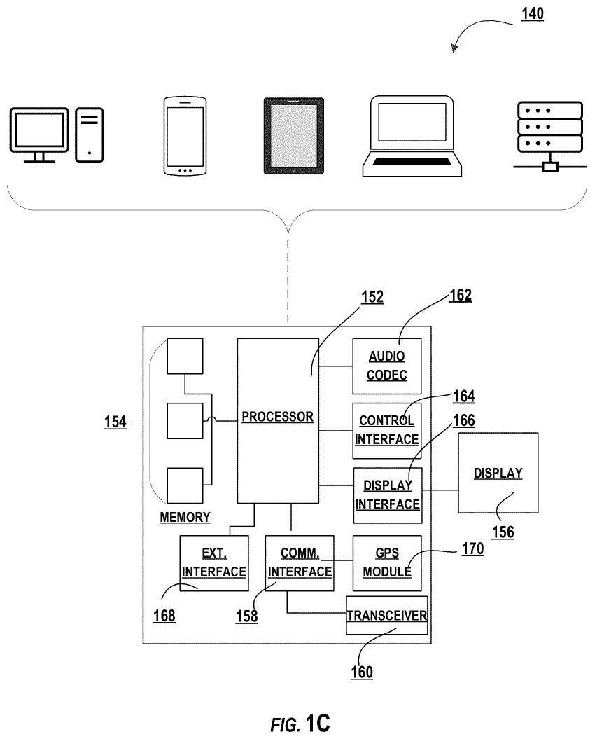

FIGS. 1A-1C illustrate technical components of an exemplary distributed computing environment 100 for validating data transfers in a decentralized protocol via embedded rule logic, in accordance with implementations of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an implementation of the distributed computing environment 100, and it will be appreciated that in other implementations one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some implementations, the system 130 and the endpoint device(s) 140 may have a client-server relationship in which the endpoint device(s) 140 are remote devices that request and receive application from a centralized server, i.e., the system 130. In some other implementations, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, input devices such as resource transfer terminals, electronic resource transfer units, and/or the like, electronic telecommunications device (e.g., automated teller machine (“ATM”)), and/or edge devices such as routers, routing switches, integrated access devices (“IAD”), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with implementations of the disclosure. As shown in FIG. 1B, the system 130 may include a processing device 102, memory 104, input/output (“I/O”) device 116, and a storage device 106. The system 130 may also include a high-speed interface 108 connecting to the memory 104, and a low-speed interface 112 connecting to a low-speed bus 114 and a storage device 106. Each of the components 102, 104, 108, 110, and 112 may be operatively coupled to one another using various buses and may be mounted on a common motherboard or in other manners as appropriate. As described herein, the processing device 102 may include a number of subsystems to execute the portions of processes described herein. Each subsystem may be a self-contained component of a larger system (e.g., system 130) and capable of being configured to execute specialized processes as part of the larger system.

The processing device 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processing devices, along with multiple memories, and/or I/O devices, to execute the processes described herein. In other words, as used herein, a “processing device” means one processing device (e.g., a microprocessor) that performs the defined functions or a plurality of processing devices (e.g., microprocessors) that collectively perform defined functions such that the execution of the individual defined functions may be divided amongst such processing devices.

The memory 104 stores information within the system 130. In one implementation, the memory 104 is a volatile memory unit or units, such as volatile random access memory (“RAM”) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly implemented in an information carrier. The computer program product may also contain instructions that, when executed, perform one or more methods, such as those described above. The information carrier may be a non-transitory computer-or machine-readable storage medium, such as the memory 104, the storage device 106, or memory on processing device 102.

The high-speed interface 108 manages bandwidth-intensive operations for the system 130, while the low-speed controller 112 manages lower bandwidth-intensive operations. Such allocation of functions is exemplary only. In some implementations, the high-speed interface 108 is coupled to memory 104, input/output (“I/O”) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with implementations of the disclosure. As shown in FIG. 1C, the endpoint device(s) 140 includes a processing device 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processing device 152 is configured to execute instructions within the endpoint device(s) 140, including instructions stored in the memory 154, which in one implementation includes the instructions of an application that may perform the functions disclosed herein, including certain logic, data processing, and data storing functions. The processing device may be implemented as a chipset of chips that include separate and multiple analog and digital processors. The processing device may be configured to provide, for example, for coordination of the other components of the endpoint device(s) 140, such as control of user interfaces, applications run by endpoint device(s) 140, and wireless communication by endpoint device(s) 140.

The processing device 152 may be configured to communicate with the user through control interface 164 and display interface 166 coupled to a display 156. The display 156 may be, for example, a “TFT LCD” (Thin-Film-Transistor Liquid Crystal Display) or an “OLED” (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processing device 152. In addition, an external interface 168 may be provided in communication with processing device 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a “SIMM” (Single In Line Memory Module) card interface. Such expansion memory may provide extra storage space for endpoint device(s) 140 or may also store applications or other information therein. In some implementations, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly implemented in an information carrier. The computer program product contains instructions that, when executed, perform one or more methods, such as those described herein. The information carrier is a computer-or machine-readable medium, such as the memory 154, expansion memory, memory on processing device 152, or a propagated signal that may be received, for example, over transceiver 160 or external interface 168.

In some implementations, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (“IP”) suite (commonly known as “TCP/IP”). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, “GPS” (Global Positioning System) receiver module 170 may provide additional navigation- and location-related wireless data to endpoint device(s) 140, which may be used as appropriate by applications running thereon, and in some implementations, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some implementations, one or more applications operating on the system 130.

Various implementations of the distributed computing environment 100, including the system 130 and endpoint device(s) 140, and techniques described here can be realized in digital electronic circuitry, integrated circuitry, specially designed “ASICs” (application specific integrated circuits), computer hardware, firmware, software, and/or combinations thereof.

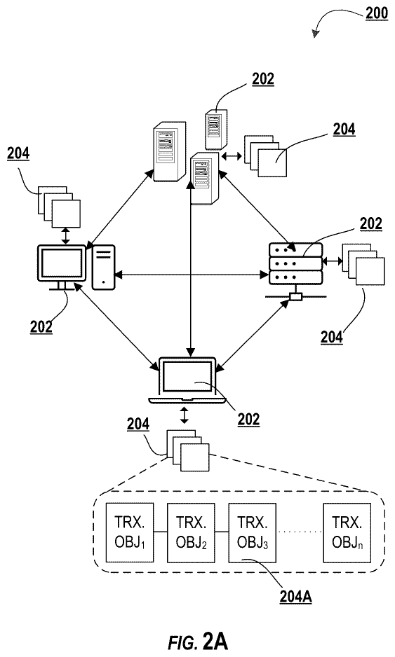

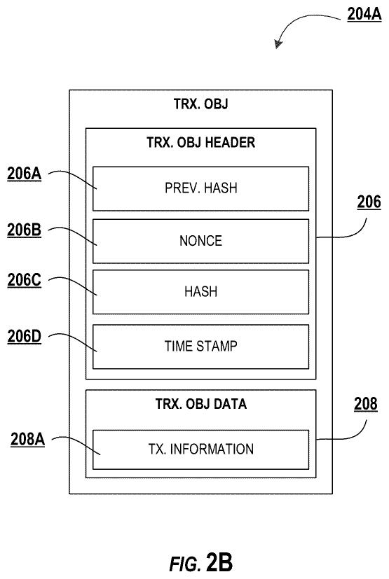

FIGS. 2A-2B illustrate an exemplary distributed ledger technology (DLT) architecture, in accordance with implementations of the disclosure. DLT may refer to the protocols and/or supporting infrastructure that allow computing devices (peers) in different locations to propose and validate data transfers and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of data transfers represented as data transfer objects that are linked. As data transfer objects each contain information about the data transfer object previous to it, they are linked with each additional data transfer object, reinforcing the data transfer objects before it. Therefore, distributed ledgers are resistant to modification of their data because once recorded, the data in any given data transfer object cannot be altered retroactively without altering all subsequent data transfer objects.

To permit data transfers and agreements to be carried out among various peers without the need for a central authority or external enforcement mechanism, DLT uses smart contracts. Smart contracts are computer code that automatically execute all of or parts of an agreement and are stored on a DLT platform. The code can either be the sole manifestation of the agreement between the parties or might complement a traditional text-based contract and execute certain provisions, such as transferring funds from Party A to Party B. The code itself may be replicated across multiple nodes (peers) and, therefore, may benefit from the security, permanence, and immutability that a distributed ledger offers. That replication also means that as each new data transfer object is added to the distributed ledger, the code is, in effect, executed. If the parties have indicated, by initiating a data transfer, that certain parameters have been met, the code will execute the step triggered by those parameters. If no such data transfer has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some implementations, a distributed ledger may be characterized as a public distributed ledger, a consortium distributed ledger, or a private distributed ledger. A public distributed ledger is a distributed ledger that anyone in the world can read, anyone in the world may send data transfers to and expect to see them included if they are valid, and anyone in the world can participate in the consensus process for determining which data transfer objects are added to the distributed ledger and what the current state of each data transfer object is. A public distributed ledger is generally considered to be fully decentralized. On the other hand, a fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that at least 10 members must sign every data transfer object in order for the data transfer object to be valid. The right to read such a distributed ledger may be public or restricted to the participants. These distributed ledgers may be considered partially decentralized.

As shown in FIG. 2A, the exemplary DLT architecture 200 may include a distributed ledger 204 being maintained on multiple devices (nodes) 202 that are authorized to keep track of the distributed ledger 204. For example, the nodes 202 may be computing devices such as the system 130 and the client device(s) 140. One node of the nodes 202 in the DLT architecture 200 may have a complete or partial copy of the entire distributed ledger 204 or may have a set of data transfers and/or data transfer objects 204A on the distributed ledger 204. Data transfers may be initiated at a node and communicated to the nodes 202 in the DLT architecture 200. Any of the nodes 202 may validate a data transfer, record the data transfer to its copy of the distributed ledger, and/or broadcast the data transfer, its validation (in the form of a data transfer object), and/or other data to other nodes.

As shown in FIG. 2B, an exemplary data transfer object 204A may include a data transfer object header 206 and data transfer object data 208. The data transfer object header 206 may include a cryptographic hash of a previous data transfer object 206A, a nonce 206B (e.g., a randomly generated 32-bit whole number when the data transfer object 204A is created), a cryptographic hash of the current data transfer object 206C wedded to the nonce 206B, and/or a time stamp 206D. The data transfer object data 208 may include data transfer information 208A being recorded. Once the data transfer object 204A is generated, the data transfer information 208A is considered signed and forever tied to the nonce 206B and the cryptographic hash 206C. Once generated, the data transfer object 204A is then deployed on the distributed ledger 204. At this time, a distributed ledger address may be generated for the data transfer object 204A (e.g., an indication of where the data transfer object 204A is located on the distributed ledger 204) and may be captured for recording purposes. Once deployed, the data transfer information 208A is considered recorded in the distributed ledger 204.

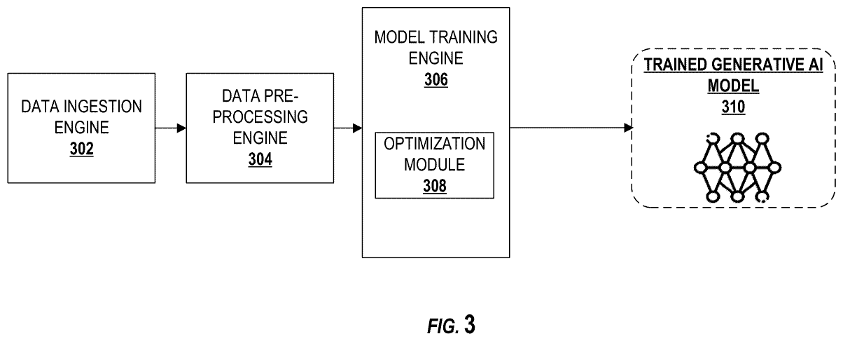

FIG. 3 illustrates an exemplary generative AI subsystem 300, in accordance with implementations of the disclosure. The generative AI subsystem 300 may include a data ingestion engine 302, a data pre-processing engine 304, and a model training engine 306, which may be configured to support training and deployment of generative models of various scales, including both large and small language models. It should be understood that the generative AI subsystem 300 is merely an example, and other implementations may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the disclosure.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some implementations, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some implementations, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 302 may move the data to a destination for storage or further analysis. Typically, the data may be in varying formats as they come from different sources, including RDBMS, other types of databases, S3 buckets, CSVs, or from streams. For a large language model (“LLM”), text data may originate from sources such as web scrapes, social media, large public text datasets, or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering. In implementations involving small language models, the data ingestion and processing pipelines may be optimized for minimal memory usage and computational efficiency, such as by limiting vocabulary size, reducing sequence length, or using quantized datasets tailored for low-power environments or on-device inference.

In machine learning, the quality of data and the useful information that can be derived therefrom directly affects the ability of the machine learning model to learn. The data pre-processing engine 304 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some implementations, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that are suitable for machine learning algorithms. In this regard, the data pre-processing engine 304 may use techniques such as one-hot encoding or label encoding depending on the nature of the categorical variables and the intended use of the data.

In some implementations, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training module 306.

The model training engine 306 may be responsible for training the generative AI models 310 using the pre-processed data from the data pre-processing engine 304. The model training engine 306 may implement various machine learning algorithms, including but not limited to Generative Adversarial Networks (GANs), Variational Autoencoders (VAEs), transformers, diffusion models, or other specialized architectures depending on the specific requirements of the system, including lightweight architectures tailored for edge deployment or constrained environments, such as distilled transformer models or compact RNN-based generators. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some implementations, the model training engine 306 may include a training data handler, which manages the partitioning of the pre-processed data into training, validation, and testing datasets. The training data is used to update the model's parameters, while the validation and testing datasets are reserved to evaluate the model's performance during and after training. The model training engine 306 may support various data-handling strategies, such as cross-validation or random shuffling, to ensure that the model generalizes well and is not overfitting to the training data.

In implementations involving large language models, the model training engine 306 may utilize transformer-based architectures, such as the Transformer, BERT, GPT, or the like, as well as reduced-size variants such as DistilBERT, TinyBERT, MobileBERT, or custom architectures adapted for real-time applications and reduced inference latency. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In implementations involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models 310, the model training engine 306, which may include an optimization module 308, may implement various optimization techniques to improve model performance and efficiency. The optimization module 308 may be responsible for continuously adjusting the internal parameters of the model using feedback from relevant loss functions tailored to the application (e.g., text, image, audio, or video generation). Techniques such as gradient clipping, learning rate scheduling, and mixed-precision training may be applied by the optimization module 308 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets. For small language models, optimization techniques may prioritize inference speed and memory efficiency, including quantization-aware training, pruning, low-rank matrix factorization, or knowledge distillation from a larger teacher model to a compact student model.

In some implementations, the model training engine 306 may implement early stopping mechanisms to prevent overfitting. Early stopping monitors the generative AI model performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or GPUs, where each node processes a portion of the data and updates the model in parallel. This may be particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model 310 in a persistent storage location for future use. In specific implementations, metadata such as the number of epochs, the final loss values, and values of learned parameters may be logged for model versioning and/or retraining at a later stage. In some implementations, the model training engine 306 may also implement transfer learning, where a pre-trained model may be fine-tuned on a smaller, domain-specific dataset. This may reduce the amount of time and data required to train a new model, especially in cases where the available data may be limited or highly specialized. In some implementations, the model training engine 306 may also implement transfer learning, where a pre-trained model—either large or small—is fine-tuned on a domain-specific dataset. For small language models, this fine-tuning process may require substantially fewer computational resources, allowing for personalization or domain adaptation in edge devices or resource-constrained systems.

In implementations involving LLMs, new output may be generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters which influence the randomness of the token sampling, enabling the generation of diverse or deterministic responses.

In image generation models, such as those using ViTs or GANs, new output may be generated by sampling from the learned distribution in the model's latent space. For GANs, the generator network creates an image by transforming random noise vectors into structured image outputs through a series of layers that learn visual features like shapes, textures, and colors. The generated image may be then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some implementations, generative AI models 310 may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the implementation of the generative AI subsystem 300 illustrated in FIG. 3 is exemplary and that other implementations may vary. The generative AI subsystem 300, as well as its constituent elements, may vary, and modifications or alternative configurations may be implemented without departing from the broader scope of the disclosure. For instance, different machine learning algorithms, data sources, optimization techniques, or training methodologies may be employed depending on system requirements, application domain, and available computational resources. Furthermore, features and functionalities described in one implementation may be combined with those of another implementation as needed, and vice versa. The generative AI subsystem 300 may also be deployed in lightweight configurations, optimized for environments with limited storage, compute, or power availability. In such cases, small language models may be used to meet operational constraints while maintaining acceptable performance for targeted applications, such as on-device assistants, embedded controllers, or task-specific dialogue agents.

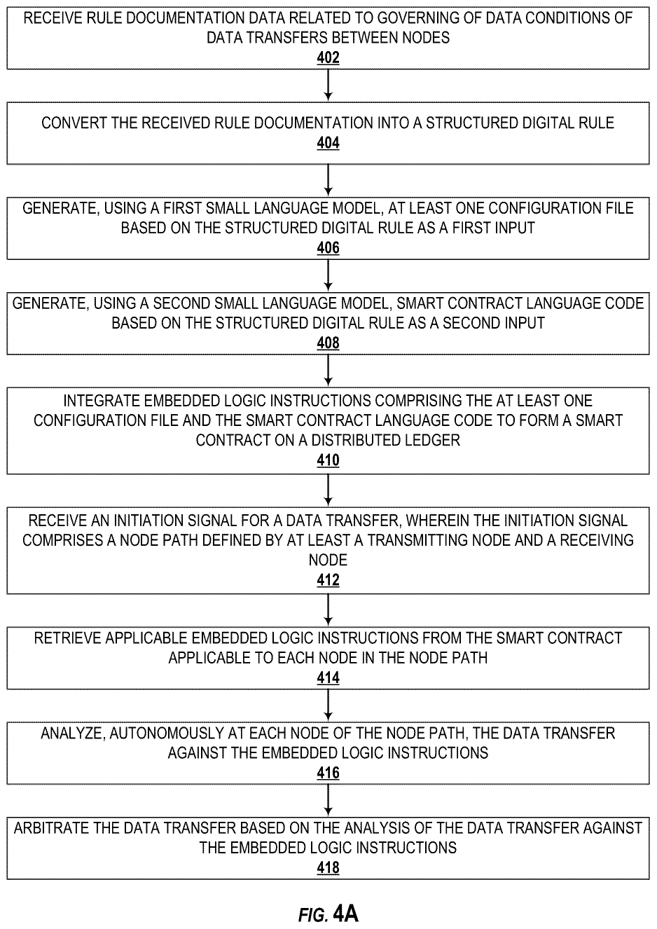

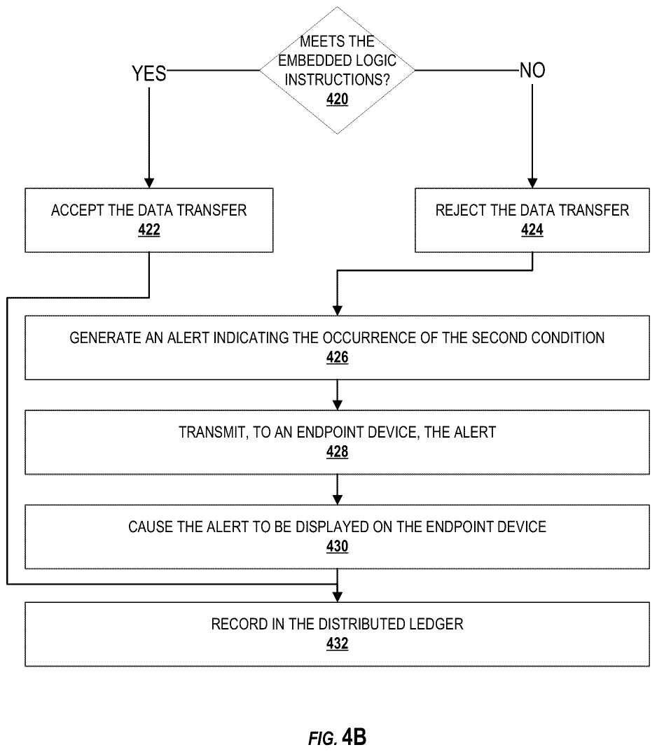

FIG. 4A illustrates a process flow for validating data transfers in a decentralized protocol via embedded rule logic, in accordance with implementations of the disclosure. At block 402 of FIG. 4A, the system 130 may receive rule documentation data.

As used herein, “rule documentation data” may refer to any collection of information, whether structured, semi-structured, or unstructured, that expresses conditions, constraints, policies, compliance requirements, or the like applicable to data transfers across a distributed system. Rule documentation data may include, but is not limited to, regulatory texts, operational guidelines, policy manuals, jurisdiction-specific directives, procedural rules, contractual terms issued by authoritative entities, or the like. Such data may exist in various formats, including documents (e.g., PDF, DOCX, TXT) in natural language or otherwise, markup-based representations (e.g., HTML, XML), scanned or image-based records (e.g., TIFF, JPEG), or other digital or digitizable forms with or without optical character recognition (“OCR”) overlays. In some implementations, an OCR engine may be executed to retrieve underlying data within rule documentation data. The term “rule documentation data” may include original source documents and/or intermediate representations thereof intended for downstream parsing, conversion, transformation, and so forth, into structured machine-readable formats and/or executable logic.

Indeed, the rule documentation data may be related to governing of data conditions of data transfers between nodes. In other words, a node may have, associated therewith, one or more rule documentation data which is intended to set forth requirements for data transfers originating from, being routed through, and/or ultimately being received by the node.

As used herein, “nodes” may refer to discrete computing entities, systems, infrastructure components, or the like that participate in the transmission, processing, validation, or recording of data transfers within a distributed network protocol. Nodes may include, but are not limited to, servers, validator instances, gateways, endpoints, smart contract execution environments, network participants responsible for enforcing embedded rule logic, or the like. A node may operate independently or as part of a federated or decentralized network and may execute localized validation operations based on preconfigured rule sets, smart contract logic, or dynamically retrieved compliance data. Nodes may also interface with external systems, provide observability features (e.g., dashboards, alerts), or serve as intermediaries through which multi-hop data transfers are routed. In some implementations, nodes may correspond to organizational entities or domains.

At block 404, the system 130 may convert the received rule documentation into a structured digital rule. In some implementations, the system 130 may apply natural language processing to identify thresholds, constraints, or the like within the unstructured rule documentation. Once parsed into semantic tokens, the elements may be mapped into predefines schema structures like policy trees, rule graphs, or the like. In some implementations, one or more generative artificial intelligence models 300 may be used to capture the rule(s) from the rule documentation and generate corresponding structured digital rule(s).

At block 406, the system 130 may generate at least one configuration file. To do so, the system 130 may use the structured digital rule determined in block 404 as an input (i.e., a “first” input) into a small language model 300 (i.e., a “first” small language model 300). The small language model 300 may be trained using sample configuration files such that, upon being input a structured digital rule, the small language model 300 generates the corresponding configuration file.

As used herein, “configuration files” may refer to structured and machine-readable data representations that encode declarative logic, parameters governing the validation, routing, and/or acceptance of data transfers within a distributed network. Configuration files may include, for example, files written in human-readable serialization formats such as YAML, JSON, or XML, and may define data transfer limits (e.g., financial transaction limits), prohibited entities, nodes, or participants, acceptable data formats, timing constraints, or any other compliance-related rule sets. These files may be generated from the rule documentation data and thereby provide an intermediate layer between unstructured policy sources and executable smart contract logic. These configuration files, as a result of the system 130 described herein, may be updated in real-time, may be version-controlled, and may be consumed by nodes during runtime to enforce logic in a consistent manner across heterogeneous environments.

To improve the performance and accuracy of the first small language model 300 over time, the system 130 may incorporate a continuous training and feedback loop in which outputs (e.g., the generated configuration files) are compared against known-valid samples, outcome, or the like. Upon a condition where a discrepancy or rule misalignment is detected, such deviations may be used to fine-tune the model using supervised learning techniques or prompt-tuning strategies targeted to the domain of regulatory interpretation. In certain implementations, feedback from downstream nodes or validators, such as rejections of malformed or non-conforming configuration files, may be logged and analyzed as part of an active reinforcement signal to adjust model parameters or retrain on corrected examples.

The actual output of the small language model 300 may include one or more serialized files in YAML, JSON, XML, or the like format that embeds key-value mappings that reflect the underlying logic of the structured digital rule. For example, mappings may include fields for data transfer limits, restricted entities, accepted data types, required signatures, geographic constraints, or the like. In some implementations, the system 130 may annotate configurations file with metadata indicating source, timestamp, version number, validation status, or the like, to build a traceability structure to support validation at distributed nodes and/or auditable by human reviewers.

At block 408, the system 130 may generate, using a small language model 300 (i.e., a “second” small language model 300), smart contract language code. It shall be appreciated that in some implementations, the second small language model 300 may be distinct from the first small language model 300. However, in other implementations, the same small language model 300 may be used to accomplish the functions described herein as being attributable to the first and second small language models.

The second small language model 300 may use structured digital rule as an input (i.e., a “second” input) to result in the output of the smart contract language code. To do so, the second small language model 300 may be trained using sample smart contract code.

For example, the second small language model 300 may be trained using annotated pairs of structured rules and corresponding executable logic written in smart contract languages tailored to a given decentralized platform. The performance of the second small language model 300 may be improved over time through reinforcement learning from deployment outcomes, including successful versus failed contract execution events, efficiency metrics, audit flags, or the like. The system 130 may incorporate active learning cycles in which edge-case rules or ambiguous structured inputs are flagged for annotation by a human, then reintroduced into the training dataset to enhance precision and reduce logic errors.

The actual output of the second small language model 300 may include one or more source files containing condition-based logic constructs like various blocks, event triggers, modifier declarations, or the like, that enforce the rules embedded in the structured digital rule. For example, a rule specifying a data transfer limit may be converted into a conditional statement rejecting any data transfer above a threshold value. As another example, a restricted entity list may be compiled into address-based access control logic to reject data transfers from predetermined entities. As with the first small language model 300, the second small language model 300 may include metadata. In such implementations, the metadata may include comments linking one or more logic blocks to its originating rule reference. In doing so, a traceable system is constructed for downstream audits or updates.

In some implementations, the first small language model 300 may be executed in parallel with the second small language model 300, such that the configuration file(s) and smart contract language code are produced by their respective models at approximately the same time. In other implementations, the first small language model 300 may be executed in series with the second small language model 300, such that either the configuration file(s) or the smart contract language code is generated prior to the other.

At block 410, the system 130 may integrate embedded logic instructions to form a smart contract on a distributed ledger. To integrate embedded logic instructions to form a smart contract is to assemble previously generated components (e.g., at least one configuration file and the smart contract language code) into an executable unit of code suitable for deployment on a distributed network. Integration may include embedding these logic instructions into the structural framework of a smart contract, for example by initializing variables with values sourced from the configuration file, defining control flow, linking enforcement conditions to relevant data transfer handlers, or the like. For example, a data transfer limit specified in the configuration file may appear in the smart contract as a hard-coded or dynamically referenced constant.

At block 412, the system 130 may receive an initiation signal for a data transfer. Indeed, upon a condition where a data transfer is to occur (i.e., is requested to occur), the system 130 may detect such condition by receipt of the initiation signal. In some implementations, the initiation signal may be a data payload or data transfer request generated by an endpoint device 140, application, or the like, and may include metadata such as source node identifier (i.e., a transmitting node identifier), destination node identifier (i.e., a receiving node identifier), routing node identifier (i.e., an intermediary node identifier), node path (i.e., the path from the transmitting node to receiving node and any intermediary nodes therebetween) data classification, requested data transfer amount or scope, timestamp, required authentication, or the like. In some implementations, the initiation signal may be transmitted through an application programming interface (API), a blockchain data transfer invocation, or other type of messaging protocol.

At block 414, the system 130 may retrieve (i.e., activate) applicable embedded logic instructions from the smart contract applicable to each node in the node path. The signal of block 412 may act as a trigger that prompts the system 130 to retrieve relevant configuration files and activate corresponding smart contract logic for validation. The system 130 may parse the included attributes in the initiation signal (e.g., source, destination, value, or the like) and associate them with applicable rules defined in the configuration files. These values may then be evaluated against the enforcement conditions encoded within the smart contract. Indeed, at block 416, the system 130 may analyze the data transfer against the embedded logic instructions. In some implementations, such analysis may occur autonomously at each node of the node path. In other words, the system 130 may perform the analysis at each node by accessing the relevant configuration file parameters and executing the corresponding portion of the smart contract logic to determine whether the data transfer complies with applicable rules specific to that node. As such, in some implementations, if the data transfer satisfies all encoded conditions at a given node, the transfer may be passed forward to the next node in the path for further analysis and validation. Additionally, or alternatively, in some implementations, if any node detects a violation of the embedded logic instructions, it may reject the transfer. As a result of the foregoing, the present system 130 provides for a series of checks that reduce the likelihood of manipulation of data transfers, misinterpretation of corresponding rules in the smart contract, or the like.

At block 418, the system 130 may arbitrate the data transfer based on the analysis of the data transfer against the embedded logic instructions. It shall be appreciated that, while an overarching system may analyze the data transfer at each node, some implementations of the disclosure provide for a segmented system where each node operates independently in its analysis. In such implementations, one main system 130 may operate as a controller, with each node performing analysis (e.g., the analysis of block 416) independently and communicating the result of the analysis to the controller, which then may direct the flow of data (e.g., the arbitration of block 418) to subsequent node(s), arrange for recordation of the data transfer and/or the results of the analysis (or analyses) on the distributed ledger, and so forth.

Arbitration of the data transfer may, in some implementations, refer to the proceeding of the transferring of the data to a subsequent node (e.g., an intermediary node, receiving node, or the like). Additionally, or alternatively, arbitration of the data transfer may include handling the data in different ways based on whether the data transfer meets the embedded logic instructions in block 416. FIG. 4B illustrates a process flow with respect to the latter, in accordance with implementations of the disclosure. Block 420, which primarily represents the same analysis as that of block 416, is shown in FIG. 4B primarily for the sake of clarity. Indeed, the system 130 at block 420 determines whether the data transfer meets the embedded logic instructions.

At block 422, the data transfer may be accepted if the data transfer meets the embedded logic instructions. Such a “first condition” may occur upon successful evaluation of the data transfer attributes against all applicable rule parameters defined in the configuration file and enforced by the smart contract logic. This may include, for example, confirmation that the data transfer amount falls within predetermined limits, that the sender and recipient identifiers are not listed among prohibited entities, that the timing of the transfer complies with any predefined temporal constraints, that the data format adheres to required structural or semantic specifications, or the like. Upon satisfaction of all such conditions, the system 130 may permit the transfer to proceed to its intended destination, optionally logging the approval decision and/or associated metadata to the distributed ledger. This may involve relaying the data transfer payload to the destination node (and any intermediate nodes), invoking a contract-defined transfer function, or the like. The transfer may occur in real-time or in accordance with the protocol defined in the configuration file.

In some implementations, the first condition may occur only if all of the data transfer attributes meet the applicable rule parameters defined in the configuration file and enforced by the smart contract logic. In other implementations, the first condition may occur if a predetermined percentage of the data transfer attributes meet the applicable rule parameters defined in the configuration file and enforced by the smart contract logic.

Alternatively, at block 424, the data transfer may be rejected if the data transfer does not meet the embedded logic instructions. Such a “second condition” may occur upon unsuccessful evaluation of the data transfer attributes against all applicable rule parameters defined in the configuration file and enforced by the smart contract logic. In other words, the data transfer attributes may not meet the applicable rule parameters.

In some implementations, the second condition may occur only if all of the data transfer attributes do not meet the applicable rule parameters defined in the configuration file and enforced by the smart contract logic. In other implementations, the second condition may occur if a predetermined percentage of the data transfer attributes do not meet the applicable rule parameters defined in the configuration file and enforced by the smart contract logic.

Occurrence of the second condition may result in one or more actions. In some implementations, occurrence of the second condition may result in halting of the data transfer altogether. In such implementations, the data transfer may be reversed such that any data reverts to the source node. In some implementations, the system 130 may further generate a rejection event that includes a failure reason code, associated rule violation, a timestamp, or any combination thereof, which may be logged in the distributed ledger for auditability.

Additionally, or alternatively, occurrence of the second condition may result in flagging the data transfer in the distributed ledger. Such flagging may include assigning a non-compliance status code, linking the flagged entry to the specific node that triggered the rejection, appending metadata such as rule identifiers, transfer parameters, and evaluation context, and so forth. As a result, the flag may be cryptographically bound to the original transfer request. In some implementations, flagged entries may be indexed or classified to enable downstream querying, batch analysis, or real-time monitoring by authorized systems or oversight entities.

Additionally, or alternatively, occurrence of the second condition may result in documenting in the distributed ledger reasons for the second condition. This documentation may include a structured log entry indicating the specific embedded logic instruction that was violated, the exact value or attribute that caused the failure, any contextual information for reconstructing the evaluation event, or the like. In some implementations, the ledger entry may also reference the applicable configuration file version and the smart contract logic instance used during evaluation.

In some implementations, the system 130 may invoke a generative artificial intelligence model 300 to produce a natural language explanation describing why the data transfer failed (i.e., why there is an occurrence of the second condition). This explanation may reference the relevant rule, compare the expected versus actual values, and clarify the failure condition in a human-readable format. The generated explanation may be appended to the distributed ledger entry alongside technical metadata to provide human-explainable context for the occurrence of the second condition.

At block 426, upon occurrence of the second condition, the process may continue where the system 130 generates an alert indicating the occurrence of the second condition. In some implementations, the alert may include metadata identifying one or more of: the specific node or system component that triggered the failure, a timestamp of the rejection event, a unique data transfer identifier, a classification of the violation type (e.g., threshold breach, prohibited recipient, invalid format), or the like. Additionally, or alternatively, the alert may include a reference to the applicable configuration file version or rule identifier, enabling traceability and correlation with prior rule updates or contract versions. Additionally, or alternatively, a generative artificial intelligence model 300 may be used to produce a natural language explanation describing why there is an occurrence of the second condition. This generating of the natural language explanation may be similar to that which is generated in implementations where a natural language explanation is appended to the distributed ledger as previously described. Instead, the natural language explanation may be provided in the data that comprises an alert, where the alert data ultimately causes the display of the alert. In other words, this natural language explanation may include text that, as a result of subsequent processes, is displayed at an endpoint device 140. This explanation may reference the relevant rule, compare the expected versus actual values, clarify the failure condition, or the like, in a human-readable format.

At block 428, the system 130 may transmit the alert to an endpoint device 140. In some implementations, the alert may be transmitted to designated monitoring entities (e.g., predetermined endpoint devices). Additionally, or alternatively, the alert may invoke a remediation protocol, such as initiating a secondary validation attempt, requesting updated rule documentation, quarantining the data for manual review, and so forth. At block 430, the system 130 may cause the alert to be displayed on the endpoint device 140. If the alert is of a type intended for human review, the display may include a summary of the failure event, the data transfer ID, and/or a natural language explanation identifying the rule that was violated. In some cases, the alert may also include a suggested corrective action (e.g., generated by a generative AI having been trained to recommend corrective actions based on learning from past corrective actions), a link to the relevant configuration file, and/or a timeline of the data transfer's progression through the system 130. Depending on the implementation, the alert may appear in a system dashboard, an audit interface, a compliance monitoring terminal, or other visualization layers.

At block 432, the system may record the data transfer, or lack thereof, in a distributed ledger. This record may include metadata such as the data transfer identifier, source, intermediate, and/or destination node identifiers, timestamp of the transfer attempt, evaluation outcome (e.g., approved, rejected), and any applicable rule identifiers or configuration file references used during validation. In the case of a failed data transfer, the record may further include the reason for failure, including a pointer to the specific embedded logic instruction or rule that was violated. In some implementations, the record may also include a hash of the associated configuration file or smart contract logic version to ensure auditability and immutability. If a natural language explanation was generated, that explanation may also be logged in the ledger entry, either directly or as a linked artifact. As a result of the foregoing, this entry allows for traceability of the data transfer event.

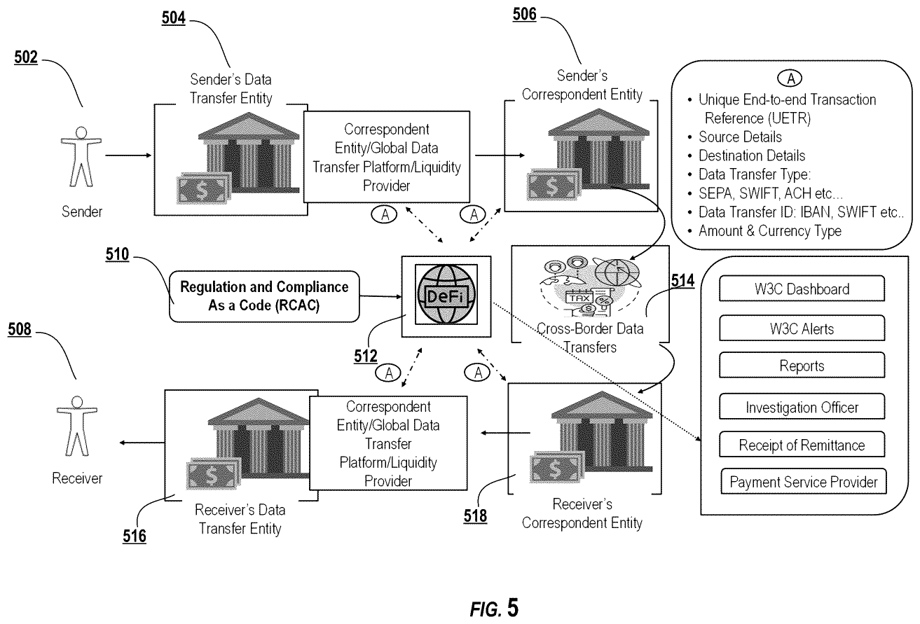

FIG. 5 illustrates an architecture layout of an exemplary system for validating data transfers in a decentralized protocol via embedded rule logic, in accordance with implementations of the disclosure. As shown in FIG. 5, a data transfer may originate from a sender 502, which communicates a data payload to a sender data transfer entity 504. The sender data transfer entity 504 may function as an initial processing node that manages origination metadata and prepares the data transfer for routing. The data may then flow to a sender correspondent entity 506, which may serve as an intermediary gateway within a distributed or federated system.

From the sender correspondent entity 506, the data transfer may proceed through a cross-border data transfers block 514, which represents a routing layer responsible for facilitating multi-jurisdictional propagation and protocol-aware interoperability. On the receiving side, the data is received by a receiver correspondent entity 518, which then passes the data to a receiver data transfer entity 516 and ultimately delivers the data to the receiver 508.

The sender data transfer entity 504, sender correspondent entity 506, receiver correspondent entity 518, and receiver data transfer entity 516 may maintain bi-directional communication with a decentralized finance (“DeFi”) block 512. This allows access to shared compliance data and validation references. The arrows represent dynamic lookups or exchanges of validation artifacts, including end-to-end data transfer references, source node and destination node details, transfer classifications, data transfer identifiers, data transfer amounts, or the like.

The DeFi block 512 may function as a system of record and execution platform and may receive embedded rule logic from a Regulation and Compliance as a Code (“RCAC”) block 510, which may represent one or more systems that transform compliance documentation into machine-executable rules. This injection of embedded rule logic may govern how the DeFi layer validates and processes data transfers.

The DeFi block 512 may also be operable in conjunction with multiple observability and oversight mechanisms, including a W3C (World Wide Web Consortium) dashboard, W3C alerts, reports, audit interfaces, or the like. The DeFi block 512 may further support functionality for audit personnel, receipt reconciliation (e.g., remittance tracking), integration with data transfer service providers, and so forth.

As will be appreciated by one of ordinary skill in the art, the present disclosure may be implemented as an apparatus (including, for example, a system, a machine, a device, a computer program product, and/or the like), as a method (including, for example, an enterprise process, a computer-implemented process, and/or the like), as a computer program product (including firmware, resident software, micro-code, and the like), or as any combination of the foregoing. Many modifications and other implementations of the present disclosure set forth herein will come to mind to one skilled in the art to which these implementations pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for validating data transfers in a decentralized protocol via embedded rule logic, the system comprising:
a processing device; and
a non-transitory storage device comprising instructions, when executed by the processing device, the instructions cause the processing device to perform steps of:
receiving rule documentation data related to governing of data conditions of data transfers between nodes;
converting the received rule documentation into a structured digital rule;
generating, using a first small language model, at least one configuration file based on the structured digital rule as a first input;
generating, using a second small language model, smart contract language code based on the structured digital rule as a second input; and
integrating embedded logic instructions comprising the at least one configuration file and the smart contract language code to form a smart contract on a distributed ledger.

2. The system of claim 1, wherein the instructions further cause the processing device to perform the steps of:
receiving an initiation signal for a data transfer, wherein the initiation signal comprises a node path defined by at least a transmitting node and a receiving node;
retrieving applicable embedded logic instructions from the smart contract applicable to each node in the node path;
analyzing, autonomously at each node of the node path, the data transfer against the embedded logic instructions; and
arbitrating the data transfer based on the analysis of the data transfer against the embedded logic instructions, wherein the data transfer is accepted upon a first condition where the data transfer meets the embedded logic instructions, and wherein the data transfer is rejected upon a second condition where the data transfer does not meet the embedded logic instructions.

3. The system of claim 2, wherein, upon occurrence of the second condition, the instructions further cause the processing device to perform the steps of:
generating an alert indicating the occurrence of the second condition;
transmitting, to an endpoint device, the alert; and
causing the alert to be displayed on the endpoint device.

4. The system of claim 1, wherein the first small language model is trained using sample configuration files.

5. The system of claim 1, wherein the second small language model is trained using sample smart contract code.

6. The system of claim 3, wherein the alert comprises explained reasons for the second condition.

7. The system of claim 2, wherein rejecting the data transfer upon the second condition comprises halting the data transfer, flagging the data transfer in the distributed ledger, and documenting in the distributed ledger reasons for the second condition.

8. A computer program product for validating data transfers in a decentralized protocol via embedded rule logic, the computer program product comprising a non-transitory computer-readable medium comprising code causing an apparatus to:
receive rule documentation data related to governing of data conditions of data transfers between nodes;
convert the received rule documentation into a structured digital rule;
generate, using a first small language model, at least one configuration file based on the structured digital rule as a first input;
generate, using a second small language model, smart contract language code based on the structured digital rule as a second input; and
integrate embedded logic instructions comprising the at least one configuration file and the smart contract language code to form a smart contract on a distributed ledger.

9. The computer program product of claim 8, wherein the code further causes the apparatus to:
receive an initiation signal for a data transfer, wherein the initiation signal comprises a node path defined by at least a transmitting node and a receiving node;
retrieve applicable embedded logic instructions from the smart contract applicable to each node in the node path;
analyze, autonomously at each node of the node path, the data transfer against the embedded logic instructions; and
arbitrate the data transfer based on the analysis of the data transfer against the embedded logic instructions, wherein the data transfer is accepted upon a first condition where the data transfer meets the embedded logic instructions, and wherein the data transfer is rejected upon a second condition where the data transfer does not meet the embedded logic instructions.

10. The computer program product of claim 9, wherein, upon occurrence of the second condition, the code further causes the apparatus to:
generate an alert indicating the occurrence of the second condition;
transmit, to an endpoint device, the alert; and
cause the alert to be displayed on the endpoint device.

11. The computer program product of claim 8, wherein the first small language model is trained using sample configuration files.

12. The computer program product of claim 8, wherein the second small language model is trained using sample smart contract code.

13. The computer program product of claim 10, wherein the alert comprises explained reasons for the second condition.

14. The computer program product of claim 9, wherein rejecting the data transfer upon the second condition comprises halting the data transfer, flagging the data transfer in the distributed ledger, and documenting in the distributed ledger reasons for the second condition.

15. A method for validating data transfers in a decentralized protocol via embedded rule logic, the method comprising:
receiving rule documentation data related to governing of data conditions of data transfers between nodes;
converting the received rule documentation into a structured digital rule;
generating, using a first small language model, at least one configuration file based on the structured digital rule as a first input;
generating, using a second small language model, smart contract language code based on the structured digital rule as a second input; and
integrating embedded logic instructions comprising the at least one configuration file and the smart contract language code to form a smart contract on a distributed ledger.

16. The method of claim 15, wherein the method further comprises:
receiving an initiation signal for a data transfer, wherein the initiation signal comprises a node path defined by at least a transmitting node and a receiving node;
retrieving applicable embedded logic instructions from the smart contract applicable to each node in the node path;
analyzing, autonomously at each node of the node path, the data transfer against the embedded logic instructions; and
arbitrating the data transfer based on the analysis of the data transfer against the embedded logic instructions, wherein the data transfer is accepted upon a first condition where the data transfer meets the embedded logic instructions, and wherein the data transfer is rejected upon a second condition where the data transfer does not meet the embedded logic instructions.

17. The method of claim 16, wherein, upon occurrence of the second condition, the method further comprises:
generating an alert indicating the occurrence of the second condition;
transmitting, to an endpoint device, the alert; and
causing the alert to be displayed on the endpoint device.

18. The method of claim 15, wherein the first small language model is trained using sample configuration files.

19. The method of claim 15, wherein the second small language model is trained using sample smart contract code.

20. The method of claim 16, wherein rejecting the data transfer upon the second condition comprises halting the data transfer, flagging the data transfer in the distributed ledger, and documenting in the distributed ledger reasons for the second condition.
